(19) United States
(12) Patent Application Publication
(10) Pub. No.: US 2025/0005926 A1
(43) Pub. Date: Jan. 2, 2025

(54) INTELLIGENT MONITORING AND REASONING SYSTEMS AND METHODS

(71) Applicant: ExxonMobil Technology and Engineering Company, Spring, TX (US)

(72) Inventors: Haining ZHENG, Chatham, NJ (US); Antonio PAIVA, Clinton, NJ (US); Christopher S. GURCIULLO, Bangor, PA (US)

(73) Assignee: ExxonMobil Technology and Engineering Company, Spring, TX (US)

(21) Appl. No.: 18/342,575

(22) Filed: Jun. 27, 2023

Related U.S. Application Data
(60) Provisional application No. 63/354,379, filed on Jun. 22, 2022.

(51) Int. Cl. G06V 20/40; G06T 7/20; G06V 10/82; G06V 20/52

(52) U.S. Cl. CPC G06V 20/44; G06T 7/20; G06V 10/82; G06V 20/52; G06T 2207/10016; G06T 2207/10048; G06T 2207/20076; G06T 2207/20084; G06T 2207/30196; G06T 2207/30232

(57) ABSTRACT

Systems and methods for intelligent monitoring of a site may be useful for ascertaining the operational integrity of said site. Said systems and methods may use data fusion, neural features, and integrated reasoning to achieve the intelligent monitoring. For example a method may comprise: capturing a plurality of images over time from a site; transmitting the plurality of images to a hub; identifying at least one element in at least one of the plurality of images; querying at least one sensor and/or related sensor data for at least one attribute of the at least one element; tracking the at least one element to produce spatio-temporal attributes of the at least one element; ascertaining a state of the environment at the site; and applying an integrated reasoning model to the state of the environment to identify events that may occur and/or are occurring at the site that require operator intervention.

### FIELD OF INVENTION

The present disclosure relates to systems and methods for intelligent monitoring of a site to ascertain the operational integrity of said site. Said systems and methods use data fusion, neural features, and integrated reasoning to achieve the intelligent monitoring.

### BACKGROUND

Surveillance systems manned by operators are used at a variety of industrial sites to monitor the presence and movement of workers, vehicles, and equipment. One such conventional surveillance method uses closed circuit television (CCTV) cameras that may be mounted on buildings or vehicles. The cameras may be either fixed or can be controlled to move to alter the direction of their scene of view. A security center, sometime called a “hub,” receives data from one or more cameras to allow personnel to assess video received from the one or more cameras. Based on the video personnel are able to make decisions concerning safety, security and enforcement.

In addition to manned surveillance systems, more autonomous components, such as badge or proximity sensors may also be used. In many cases, a combination of manned and unmanned systems are used, such as a manned badge-based systems for guests and an unmanned badge-based systems for employees. Generally, manned systems are more expensive to operate over time and may, in some cases, be more prone to error

### SUMMARY OF INVENTION

The present disclosure relates to systems and methods for intelligent monitoring of a site to ascertain the operational integrity of said site. Said systems and methods use data fusion, neural features, and integrated reasoning to achieve the intelligent monitoring.

A nonlimiting example method of the present disclosure comprises: capturing a plurality of images over time from a site; transmitting the plurality of images to a hub; identifying at least one element in at least one of the plurality of images; querying at least one sensor and/or related sensor data for at least one attribute of the at least one element; tracking the at least one element through the plurality of images to produce spatio-temporal attributes of the at least one element; ascertaining a state of the environment by integrating the at least one attribute and the spatio-temporal attributes of the at least one element; applying an integrated reasoning model to the state of the environment to identify one or more events that may occur and/or are occurring at the site that require operator intervention; and notifying an operator of the one or more events.

Another nonlimiting example method of the present disclosure comprises: capturing a plurality of images over time from a site; transmitting the plurality of images to a hub; identifying at least one element in at least one of the plurality of images; querying at least one sensor and/or related sensor data for at least one attribute of the at least one element; tracking the at least one element through the plurality of images to produce spatio-temporal attributes of the at least one element; applying an integrated reasoning model to ascertain the state of the environment and to identify one or more events that may occur and/or are occurring at the site that require operator intervention by integrating the at least one attribute and the spatio-temporal attributes; and notifying an operator of the one or more events.

A nonlimiting example system of the present disclosure comprises: a processor; a memory coupled to the processor; and instructions provided to the memory, wherein the instructions are executable by the processor to cause the system to perform either or both of the foregoing methods.

These and other features and attributes of the disclosed systems and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a flow diagram of a nonlimiting example method of the present disclosure.

FIG. 2 illustrates a flow diagram of another nonlimiting example method of the present disclosure.

FIG. 3 illustrates a nonlimiting example of a dynamic graph representation that may be used to describe the state of the environment.

### DETAILED DESCRIPTION

The present disclosure relates to systems and methods for intelligent monitoring of a site to ascertain the operational integrity of said site. Said systems and methods use data fusion, neural network analysis, and integrated reasoning to achieve the intelligent monitoring. The systems and methods described herein advantageously integrate data from heterogeneous sensors and analyze this data with neural networks and/or dynamic probabilistic graphical models that can provide a high-level representation of a site or portion thereof.

The autonomous nature of the data collection and analysis of the heterogeneous sensor data (e.g., cameras, badge sensors, and the like) allows for monitoring areas of the site beyond those traditionally monitored (e.g., high risk areas, entrances, and exits). Rather, a portion of the site that is low risk (e.g., a storage silo of an inert chemical) may be monitored with the systems and methods described herein, which increases the security breadth and strength at the site.

Further, the design of the systems and methods described herein use integration schemes and neural network-enhanced analysis schemes that may provide a hierarchical representation of the status of the site or portion thereof (e.g., a state of the environment). This hierarchical representation provides a high-level representation that can be readily analyzed against learned behavior for the site or portion thereof to identify potential events that may require operator intervention. The nature of how the data fusion, neural network analysis, and integrated reasoning are integrated may allow for the methods and systems to be implemented in real-time or near real-time, which allows for immediate intervention by an operator to rectify and/or mitigate potentially hazardous events.

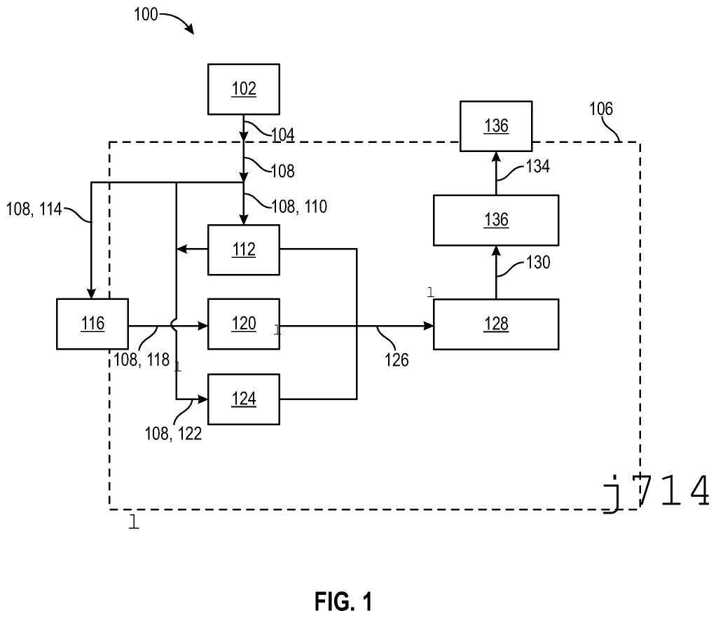

FIG. 1 illustrates a flow diagram of a nonlimiting example method 100 of the present disclosure. The method 100 includes capturing a plurality of images 102 at a site (e.g., an office site, an industrial site, hydrocarbon production site, a hydrocarbon refining site, a hydrocarbon transportation site, or the like). Examples of images that may be in the plurality of images may include, but are not limited to, visible light images (e.g., traditional photograph or video images), infrared images, ultraviolet images, thermal images, night vision images, and the like, and any combination thereof. The plurality of images may include at least a portion of one or more videos (e.g., images from a single video, images from two different videos, and the like. The source of the images may be singular (e.g., a single camera) or multiple (e.g., multiple cameras that may include cameras of the same and/or different types).

The plurality of images 102 may be transmitted 104 to a hub 106 for analysis, preferably real-time analysis. The plurality of images 102 are analyzed 108 to identify 110 at least one element 112 in at least one of the plurality of images 102. Here, identify 110 is to select (or pick) and generally identify the nature of the element (e.g., a person, a group of people, a vehicle, and the like) and not to ascertain an exact identification of the element. Examples of elements may include, but are not limited to, a person, a group of people, a vehicle, equipment or a component thereof, and the like, and any combination thereof. The level of granularity of the identification of the element may vary and/or be chosen. For example, a vehicle may be simply identified as a vehicle in this step or may be further granulated to a truck, a car, an 18-wheeler, or the like. In another example, the group of people may be simply identified as a group of people or more granulated to a group of 3-5 people or a group of 4 people.

The analysis 108 further includes querying 114 at least one sensor and/or related sensor data 116 to ascertain 118 at least one attribute 120 of the at least one element 112. The sensor collects data relating to the site and the related sensor data may be stored at the site, in the hub 106, and/or any other suitable location such that the related sensor data may be readily accessed for the method 100. Examples of sensors may include, but are not limited to, identification scanners (e.g., badge readers, license plate readers, vehicle identification sensors, toll tag sensors, and the like), barrier sensors (e.g., informing about a gate's status or whether to confirm if a person or a vehicle crossed into a section of the site), equipment sensors (e.g., temperature sensors, pressure gauges, flow meters, and the like), and the like, and any combination thereof.

Examples of attributes may include, but are not limited to, a badge identification number, a vehicle identification number, a person's name, a company associated with the at least one element (e.g., an employer of a person, an owner of a vehicle, and the like), a job title of a person, classification of work tasks, and the like, and any combination thereof.

Optionally (not illustrated), the analysis may further include querying at least one database for at least one database attribute of the at least one element. Database attributes relate to the behavior and/or location of an element exhibited previously at the site and/or other sites, or scheduling, assignment and work order information. Examples of database attributes may include, but are not limited to, a measure of time (e.g., average time, minimum time, maximum time, and the like, and any combination thereof) an element is at a site or specific location thereat (e.g., in a specific area that required badging in), scheduling information used to assess whether this particular person or vehicle is expected for a specific location, and the like, and any combination thereof.

The analysis 108 further comprises tracking 122 the at least one element 112 through the plurality of images 102 to produce spatio-temporal attributes 124 of the at least one element 112. The spatio-temporal attributes may be presented as a coordinate (e.g., GPS coordinates, coordinates relative to a different element in the plurality of images, coordinates relative to a set location like a starting location or point of identification, and the like, and any combination thereof), a graph or other pictorial representation, textual descriptions (e.g., a stopped truck, a person entering the stopped truck), previous spatio-temporal attributes for context, and the like, and any combination thereof. Depending on the length of time the tracking occurs, additional queries (not illustrated) may occur to the same or different sensor and/or related sensor data 116.

The tracking 122 may be executed using artificial neural networks. For example, the plurality of images or a portion thereof may use a convolution neural network to detect elements and assign a position to the elements for each image where the position is correlated to a time associated with the image to yield the spatio-temporal attributes. Examples of artificial neural networks may include, but are not limited to, convolution neural networks, recurrent neural networks (e.g., long-short term memory (LSTM) networks, gated recurrent unit (GRU) networks, and the like), radial basis function (RBF) networks, multilayer perceptron (MLP) neural networks, and the like, and any combination thereof. Additionally, other machine learning methods (e.g., kernel methods, random forests, adaptive boosting) may be used to detect or identify elements in the plurality of images and/or augment the results thereof.

Optionally (not illustrated), the analysis may further include facial and/or object recognition to identify safety attributes of the at least one element. Examples of safety attributes may include, but are not limited to, a presence or absence of specific personal protective equipment (e.g., a hard hat, coveralls, eye protection, and the like, and any combination thereof), proximity to hazardous equipment and/or hazardous situations (e.g., proximity to a hot or cold spot identified from thermal imaging where said hot or cold spot is a hazardous or potentially hazardous occurrence), compliance to safety guidelines (e.g., only one person performing task requiring a spotter), and the like, and any combination thereof.

Optionally (not illustrated), the analysis may further identify relational attributes between two or more of the elements. Examples of relational attributes may include, but are not limited to, an interaction between two or more elements (e.g., a person turning a knob or flipping a switch, a person interacting with on-site equipment or components thereof, a person entering or exiting a vehicle, or a vehicle or equipment thereon being linked to site equipment or components thereof like a vehicle linked to a specific tank for unloading a chemical into the tank), a proximity of two or more elements (e.g., a distance between a person and on-site equipment or components thereof or a distance between a vehicle and on-site equipment or components thereof), a dynamic relationship between two or more elements (e.g., a relative direction, velocity, and/or acceleration relationship between two or more elements), and the like, and any combination thereof.

The method 100 then integrates 126 the at least one attribute 120 and the spatio-temporal attributes 124 (and the other optional attributes, if analyzed) of the at least one element 112 to produce a state of the environment 128 being monitored (or imaged) by the plurality of images 102. The state of the environment 128 is a high-level representation of the site or portion thereof such as to enable conceptual and probabilistic reasoning for advanced reasoning and surveillance. The representation of the state of the environment 128 may be a graph; a plurality of association methods such as a combination of two or more of direct spatio-temporal links between two or more elements, fuzzy logic or membership rules, probabilistic/belief representation of confidence/significance of a given association; and the like; and any combination thereof.

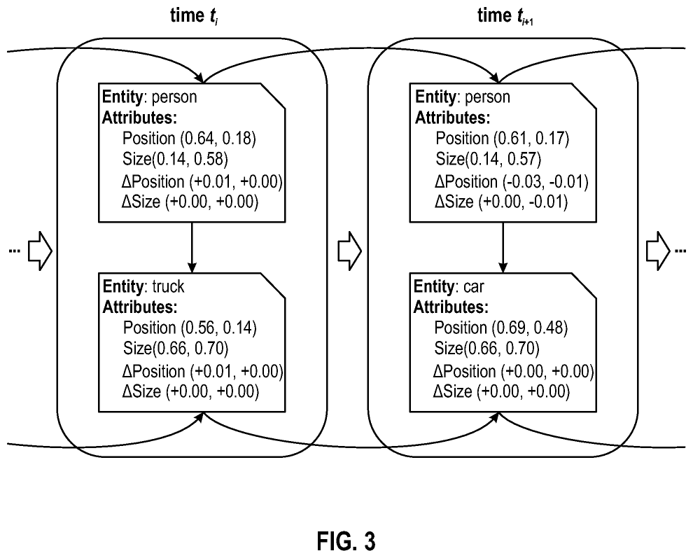

Integration 126 of the various attributes may be achieved with dynamic Bayesian networks, fuzzy neural networks, graph theory analysis, graph database collection and querying, and the like, and any combination thereof. Advantageously, dynamic Bayesian networks provide a framework to relate random variables over time but would be augmented with the multitude of attributes derived from the analysis, especially, the spatio-temporal attributes. Integration of the various attributes in this way effectively allows the method to build and maintain the state of the environment 128 (e.g., as a hierarchical dynamic graph representation that decomposes the space and time dimensions). FIG. 3 illustrates a nonlimiting example of a dynamic graph representation that may be used to describe the state of the environment 128.

The next portion of the method 100 incorporates reasoning into the method using an integrated reasoning model 132 to determine the relevance of the information in the state of the environment 128 and assess whether the information necessitates intervention by an operator. Advantageously the reasoning task is greatly facilitated by the data integration and neural features components, which provide a high-level characterization of the environment in the state of the environment 128.

Briefly, the state of the environment 128 is provided 130 as an input to the integrated reasoning model 132, which analyzes the state of the environment 128 and outputs 134 (e.g., transmits) a notification 136 to an operator who may take an appropriate action based on the notification 136. The notification 136 is based on the integrated reasoning model 132 identifying one or more events that may occur and/or are occurring at the site that require operator intervention.

The operator may be at the hub, at the site, or somewhere else such that the operator can effectively cause an appropriate action (e.g., request additional information about or from the element, remove the element from the site, close off a portion of the site, request emergency assistance, and the like, and any combination thereof).

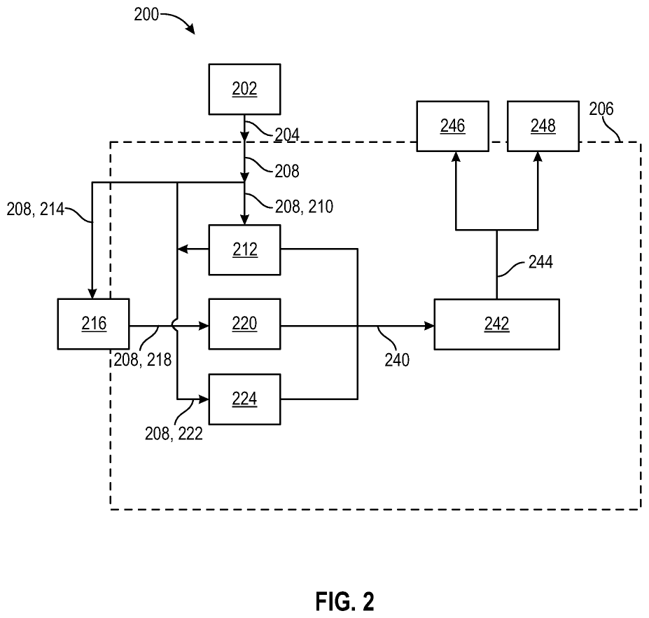

FIG. 2 illustrates a flow diagram of another nonlimiting example method 200 of the present disclosure. The method 200 includes capturing a plurality of images 202 at a site (e.g., an industrial site, hydrocarbon production site, a hydrocarbon refining site, a hydrocarbon transportation site, or the like). The description of images 102 of FIG. 1 is applicable to the images 202 of FIG. 2.

The plurality of images 202 may be transmitted 204 to a hub 206 for analysis, preferably real-time analysis. The plurality of images 202 are analyzed 208 to identify 210 (same meaning as identify 110 of FIG. 1) at least one element 212 in at least one of the plurality of images 202. The description of images 112 of FIG. 1 is applicable to the images 212 of FIG. 2.

The analysis 208 further includes querying 214 at least one sensor and/or related sensor data 216 to ascertain 218 at least one attribute 220 of the at least one element 212. The description of sensors and/or related sensor data 116 of FIG. 1 is applicable to the sensor and/or related sensor data 216 of FIG. 2. The description of attributes 120 of FIG. 1 is applicable to the attributes 220 of FIG. 2.

Optionally (not illustrated), the analysis may further include querying at least one database for at least one database attribute of the at least one element. Database attributes relate to the behavior and/or location of an element exhibited previously at the site and/or other sites, or scheduling, assignment and work order information. Examples of database attributes may include, but are not limited to, a measure of time (e.g., average time, minimum time, maximum time, and the like, and any combination thereof) an element is at a site or specific location thereat (e.g., in a specific area that required badging in), scheduling information used to assess whether this particular person or vehicle is expected for a specific location, and the like, and any combination thereof.

The analysis 208 further comprises tracking 222 the at least one element 212 through the plurality of images 202 to produce spatio-temporal attributes 224 of the at least one element 212. The spatio-temporal attributes described relative to FIG. 1 are applicable to the spatio-temporal attributes 224.

The tracking 222 may be executed using artificial neural networks. For example, the plurality of images or a portion thereof may use a convolution neural network to detect elements and assign a position to the elements for each image where the position is correlated to a time associated with the image to yield the spatio-temporal attributes. Artificial neural networks and other machine learning methods may be used to detect or identify elements in the plurality of images and/or augment the results thereof as discussed relative to FIG. 1.

Optionally (not illustrated), the analysis may further include facial and/or object recognition to identify safety attributes of the at least one element as described above relative to FIG. 1. Optionally (not illustrated), the analysis may further identify relational attributes between two or more of the elements as described above relative to FIG. 1.

The next portion of the method 200 incorporates reasoning into the method using an integrated reasoning model 242. In the illustration, the method 200 inputs 240 the at least one attribute 220 and the spatio-temporal attributes 224 (and the other optional attributes, if analyzed) of the at least one element 212 into an integrated reasoning model 242 to (1) ascertain (or derive or identify or describe) a state of the environment 246, (2) determine the relevance of the information in the state of the environment 246, and (3) assess whether the information necessitates intervention by an operator. The integrated reasoning model 242 may use dynamic Bayesian networks, fuzzy neural networks, graph theory analysis, graph database collection and querying, and the like, and any combination thereof to achieve these aims.

The representations for the state of the environment 128 of FIG. 1 are applicable to the state of the environment 246 of FIG. 2.

The integrated reasoning model 242 may output 244 (e.g., transmit, display, or the like) the state of the environment 246 and/or a notification 248 to an operator who may take an appropriate action based on the state of the environment 246 and/or the notification 248. The notification 248 is based on the integrated reasoning model 242 identifying one or more events that may occur and/or are occurring at the site that require operator intervention.

The operator may be at the hub, at the site, or somewhere else such that the operator can effectively cause an appropriate action (e.g., request additional information about or from the element, remove the element from the site, close off a portion of the site, request emergency assistance, and the like, and any combination thereof).

Described herein are two approaches for the integrated reasoning model. A first approach involves a Bayesian probabilistic model that infers the statistical relevance of the information in the state of the environment and the likelihood that a situation and/or event might require an intervention. Advantageously, the Bayesian probabilistic model approach is robust in the sense that the probabilistic structure and analysis through the model involves considering a wide range of plausible explanations for the observed data in the state of the environment. The Bayesian probabilistic model approach also naturally handles and performs reasoning even with incomplete or noisier information. The Bayesian probabilistic model approach may utilize a graph structure that will likely need a priori guidance and definition.

A second approach involves unsupervised learning of a data-driven model of normal operating conditions. Then, the relevance of information in the state of the environment can be assessed by the reasoning model based on the ability of the data-driven model to describe the said situation. For example, if the state of the environment is well described by the data-driven model then it is likely to be normal. Conversely, if the state of the environment is not well described by the data-driven model then an operator may be notified of the information in the state of the environment that is not being effectively described so that the operator can assess that portion of the state of the environment and take an appropriate action.

The specific architecture of the data-driven model will depend on the representation of the state of the environment and attributes thereof. Examples of architecture may include, but are not limited to, convolution neural network architectures (e.g., graph convolution neural network architecture), graph neural networks, Bayesian neural networks or variational approximations thereof, and the like, and any combination thereof. Additionally, other machine learning methods (e.g., neural networks, kernel methods, random forests, adaptive boosting) may be used to implement or augment specific aspects of the architecture.

Without being limited by theory, regardless of the architecture, it is believed that unsupervised learning of the model may involve a training framework wherein the data-driven model receives as input the state of the environment and then estimate a future state of the environment. For example, with a graph representation of the state of the environment, a graph convolution neural network architecture may be used to take the current graph (e.g., elements and their attributes) and predict the graph at the subsequent time step. The forward estimation of the state of the environment may be done directly or using recurrent neural networks to learn latent state information that would be useful in describing the history of or changes in the environment and/or in the interactions between different elements under analysis.

The methods described herein may, and in many embodiments must, be performed, at least in part, using computing devices or processor-based devices that include a processor; a memory coupled to the processor; and instructions provided to the memory, wherein the instructions are executable by the processor to perform the methods described herein (such as computing or processor-based devices may be referred to generally by the shorthand “computer”).

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

For example, a system may comprise: a processor; a memory coupled to the processor; and instructions provided to the memory, wherein the instructions are executable by the processor to cause the system to: capture a plurality of images over time from a site; transmit the plurality of images to a hub; identify at least one element in at least one of the plurality of images; query at least one sensor and/or related sensor data for at least one attribute of the at least one element; track the at least one element through the plurality of images to produce spatio-temporal attributes of the at least one element; ascertain a state of the environment by integrating the at least one attribute and the spatio-temporal attributes of the at least one element; apply an integrated reasoning model to the state of the environment to identify one or more events that may occur and/or are occurring at the site that require operator intervention; and notify an operator of the one or more events.

### Additional Embodiments

Embodiment 1. A method comprising: capturing a plurality of images over time from a site; transmitting the plurality of images to a hub; identifying at least one element in at least one of the plurality of images; querying at least one sensor and/or related sensor data for at least one attribute of the at least one element; tracking the at least one element through the plurality of images to produce spatio-temporal attributes of the at least one element; ascertaining a state of the environment by integrating the at least one attribute and the spatio-temporal attributes of the at least one element; applying an integrated reasoning model to the state of the environment to identify one or more events that may occur and/or are occurring at the site that require operator intervention; and notifying an operator of the one or more events.

Embodiment 2. The method of claim 1, wherein the plurality of images are at least a portion of a video.

Embodiment 3. The method of any preceding Embodiment, wherein the plurality of images comprise a visible light image, an infrared image, an ultraviolet image, a thermal image, a night vision image, or any combination thereof.

Embodiment 4. The method of any preceding Embodiment, wherein the plurality of images comprise images from two or more different videos.

Embodiment 5. The method of any preceding Embodiment, wherein the one or more elements comprise a person, a group of people, a vehicle, equipment or a component thereof, or any combination thereof.

Embodiment 6. The method of any preceding Embodiment, wherein the at least one sensor comprises an identification scanner, a barrier sensor, an equipment sensor, and any combination thereof.

Embodiment 7. The method of any preceding Embodiment, wherein the at least one attribute comprises a badge identification number, a vehicle identification number, a person's name, a company associated with the at least one element, a job title of a person, and any combination thereof.

Embodiment 8. The method of any preceding Embodiment further comprising: querying at least one database for at least one database attribute of the at least one element.

Embodiment 9. The method of any preceding Embodiment, wherein the tracking uses a convolution neural network to analyze a position of the at least one element through the plurality of images

Embodiment 10. The method of any preceding Embodiment, wherein the ascertaining of the state of the environment further integrates the at least one attribute and the spatio-temporal attributes with one or more of (a) at least one database attribute. (b) at least one safety attribute, or (c) at least one relational attribute.

Embodiment 11. The method of any preceding Embodiment, wherein the integrating uses a dynamic Bayesian network.

Embodiment 12. The method of any preceding Embodiment, wherein the integrated reasoning model incorporates a Bayesian probabilistic model.

Embodiment 13. The method of any preceding Embodiment, wherein the integrated reasoning model incorporates a data-driven model.

Embodiment 14. A system may comprise: a processor; a memory coupled to the processor; and instructions provided to the memory, wherein the instructions are executable by the processor to cause the system to: capture a plurality of images over time from a site; transmit the plurality of images to a hub; identify at least one element in at least one of the plurality of images; query at least one sensor and/or related sensor data for at least one attribute of the at least one element; track the at least one element through the plurality of images to produce spatio-temporal attributes of the at least one element; ascertain a state of the environment by integrating the at least one attribute and the spatio-temporal attributes of the at least one element; apply an integrated reasoning model to the state of the environment to identify one or more events that may occur and/or are occurring at the site that require operator intervention; and notify an operator of the one or more events.

Embodiment 15. The system of claim 14, wherein the plurality of images are at least a portion of a video.

Embodiment 16. The system of any one of Embodiments 14-15, wherein the plurality of images comprise a visible light image, an infrared image, an ultraviolet image, a thermal image, a night vision image, or any combination thereof.

Embodiment 17. The system of any one of Embodiments 14-16, wherein the plurality of images comprise images from two or more different videos.

Embodiment 18. The system of any one of Embodiments 14-17, wherein the one or more elements comprise a person, a group of people, a vehicle, equipment or a component thereof, or any combination thereof.

Embodiment 19. The system of any one of Embodiments 14-18, wherein the at least one sensor comprises an identification scanner, a barrier sensor, an equipment sensor, and any combination thereof.

Embodiment 20. The system of any one of Embodiments 14-19, wherein the at least one attribute comprises a badge identification number, a vehicle identification number, a person's name, a company associated with the at least one element, a job title of a person, and any combination thereof.

Embodiment 21. The system of any one of Embodiments 14-20, wherein the system is further caused to: query at least one database for at least one database attribute of the at least one element.

Embodiment 22. The system of any one of Embodiments 14-21, wherein the tracking uses a convolution neural network to analyze a position of the at least one element through the plurality of images

Embodiment 23. The system of any one of Embodiments 14-22, wherein the ascertaining of the state of the environment further integrates the at least one attribute and the spatio-temporal attributes with one or more of (a) at least one database attribute. (b) at least one safety attribute, or (c) at least one relational attribute.

Embodiment 24. The system of any one of Embodiments 14-23, wherein the integrating uses a dynamic Bayesian network.

Embodiment 25. The system of any one of Embodiments 14-24, wherein the integrated reasoning model incorporates a Bayesian probabilistic model.

Embodiment 26. The system of any one of Embodiments 14-25, wherein the integrated reasoning model incorporates a data-driven model.

Embodiment 27. A method comprising: capturing a plurality of images over time from a site; transmitting the plurality of images to a hub; identifying at least one element in at least one of the plurality of images; querying at least one sensor and/or related sensor data for at least one attribute of the at least one element; tracking the at least one element through the plurality of images to produce spatio-temporal attributes of the at least one element; applying an integrated reasoning model to ascertain the state of the environment and to identify one or more events that may occur and/or are occurring at the site that require operator intervention by integrating the at least one attribute and the spatio-temporal attributes; and notifying an operator of the one or more events.

Embodiment 28. The method of Embodiment 27, wherein the plurality of images are at least a portion of a video.

Embodiment 29. The method of any one of Embodiments 27-28, wherein the plurality of images comprise a visible light image, an infrared image, an ultraviolet image, a thermal image, a night vision image, or any combination thereof.

Embodiment 30. The method of any one of Embodiments 27-29, wherein the plurality of images comprise images from two or more different videos.

Embodiment 31. The method of any one of Embodiments 27-30, wherein the one or more elements comprise a person, a group of people, a vehicle, equipment or a component thereof, or any combination thereof.

Embodiment 32. The method of any one of Embodiments 27-31, wherein the at least one sensor comprises an identification scanner, a barrier sensor, an equipment sensor, and any combination thereof.

Embodiment 33. The method of any one of Embodiments 27-32, wherein the at least one attribute comprises a badge identification number, a vehicle identification number, a person's name, a company associated with the at least one element, a job title of a person, and any combination thereof.

Embodiment 34. The method of any one of Embodiments 27-33 further comprising: querying at least one database for at least one database attribute of the at least one element.

Embodiment 35. The method of any one of Embodiments 27-34, wherein the tracking uses a convolution neural network to analyze a position of the at least one element through the plurality of images

Embodiment 36. The method of any one of Embodiments 27-35, wherein the integrating of the at least one attribute and the spatio-temporal attributes further integrates with one or more of (a) at least one database attribute, (b) at least one safety attribute, or (c) at least one relational attribute.

Embodiment 37. The method of any one of Embodiments 27-36, wherein the integrating uses a dynamic Bayesian network.

Embodiment 38. The method of any one of Embodiments 27-37, wherein the integrated reasoning model incorporates a Bayesian probabilistic model.

Embodiment 39. The method of any one of Embodiments 27-38, wherein the integrated reasoning model incorporates a data-driven model.

Embodiment 40. A system may comprise: a processor; a memory coupled to the processor; and instructions provided to the memory, wherein the instructions are executable by the processor to cause the system to: capture a plurality of images over time from a site; transmit the plurality of images to a hub; identify at least one element in at least one of the plurality of images; query at least one sensor and/or related sensor data for at least one attribute of the at least one element; track the at least one element through the plurality of images to produce spatio-temporal attributes of the at least one element; apply an integrated reasoning model to ascertain the state of the environment and to identify one or more events that may occur and/or are occurring at the site that require operator intervention by integrating the at least one attribute and the spatio-temporal attributes; and notify an operator of the one or more events.

Embodiment 41. The system of Embodiment 40, wherein the plurality of images are at least a portion of a video.

Embodiment 42. The system of any one of Embodiments 40-41, wherein the plurality of images comprise a visible light image, an infrared image, an ultraviolet image, a thermal image, a night vision image, or any combination thereof.

Embodiment 43. The system of any one of Embodiments 40-42, wherein the plurality of images comprise images from two or more different videos.

Embodiment 44. The system of any one of Embodiments 40-43, wherein the one or more elements comprise a person, a group of people, a vehicle, equipment or a component thereof, or any combination thereof.

Embodiment 45. The system of any one of Embodiments 40-44, wherein the at least one sensor comprises an identification scanner, a barrier sensor, an equipment sensor, and any combination thereof.

Embodiment 46. The system of any one of Embodiments 40-45, wherein the at least one attribute comprises a badge identification number, a vehicle identification number, a person's name, a company associated with the at least one element, a job title of a person, and any combination thereof.

Embodiment 47. The system of any one of Embodiments 40-46, wherein the system is further caused to: query at least one database for at least one database attribute of the at least one element.

Embodiment 48. The system of any one of Embodiments 40-47, wherein the tracking uses a convolution neural network to analyze a position of the at least one element through the plurality of images

Embodiment 49. The system of any one of Embodiments 40-48, wherein the integrating of the at least one attribute and the spatio-temporal attributes further integrates with one or more of (a) at least one database attribute, (b) at least one safety attribute, or (c) at least one relational attribute.

Embodiment 50. The system of any one of Embodiments 40-49, wherein the integrating uses a dynamic Bayesian network.

Embodiment 51. The system of any one of Embodiments 40-50, wherein the integrated reasoning model incorporates a Bayesian probabilistic model.

Embodiment 52. The system of any one of Embodiments 40-51, wherein the integrated reasoning model incorporates a data-driven model.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
capturing a plurality of images over time from a site;
transmitting the plurality of images to a hub;
identifying at least one element in at least one of the plurality of images;
querying at least one sensor and/or related sensor data for at least one attribute of the at least one element;
tracking the at least one element through the plurality of images to produce spatio-temporal attributes of the at least one element;
ascertaining a state of the environment by integrating the at least one attribute and the spatio-temporal attributes of the at least one element;
applying an integrated reasoning model to the state of the environment to identify one or more events that may occur and/or are occurring at the site that require operator intervention; and
notifying an operator of the one or more events.

2. The method of claim 1, wherein the plurality of images are at least a portion of a video.

3. The method of claim 1, wherein the plurality of images comprise a visible light image, an infrared image, an ultraviolet image, a thermal image, a night vision image, or any combination thereof.

4. The method of claim 1, wherein the plurality of images comprise images from two or more different videos.

5. The method of claim 1, wherein the one or more elements comprise a person, a group of people, a vehicle, equipment or a component thereof, or any combination thereof.

6. The method of claim 1, wherein the at least one sensor comprises an identification scanner, a barrier sensor, an equipment sensor, and any combination thereof.

7. The method of claim 1, wherein the at least one attribute comprises a badge identification number, a vehicle identification number, a person's name, a company associated with the at least one element, a job title of a person, and any combination thereof.

8. The method of claim 1 further comprising:
querying at least one database for at least one database attribute of the at least one element.

9. The method of claim 1, wherein the tracking uses a convolution neural network to analyze a position of the at least one element through the plurality of images.

10. The method of claim 1, wherein the ascertaining of the state of the environment further integrates the at least one attribute and the spatio-temporal attributes with one or more of (a) at least one database attribute, (b) at least one safety attribute, or (c) at least one relational attribute.

11. The method of claim 1, wherein the integrating uses a dynamic Bayesian network.

12. The method of claim 1, wherein the integrated reasoning model incorporates a Bayesian probabilistic model.

13. The method of claim 1, wherein the integrated reasoning model incorporates a data-driven model.

14. A system may comprise:
a processor;
a memory coupled to the processor; and
instructions provided to the memory, wherein the instructions are executable by the processor to cause the system to:
capture a plurality of images over time from a site;
transmit the plurality of images to a hub; identify at least one element in at least one of the plurality of images;
query at least one sensor and/or related sensor data for at least one attribute of the at least one element;
track the at least one element through the plurality of images to produce spatio-temporal attributes of the at least one element;
ascertain a state of the environment by integrating the at least one attribute and the spatio-temporal attributes of the at least one element;
apply an integrated reasoning model to the state of the environment to identify one or more events that may occur and/or are occurring at the site that require operator intervention; and
notify an operator of the one or more events.

15. A method comprising:
capturing a plurality of images over time from a site;
transmitting the plurality of images to a hub;
identifying at least one element in at least one of the plurality of images;
querying at least one sensor and/or related sensor data for at least one attribute of the at least one element;
tracking the at least one element through the plurality of images to produce spatio-temporal attributes of the at least one element;
applying an integrated reasoning model to ascertain the state of the environment and to identify one or more events that may occur and/or are occurring at the site that require operator intervention by integrating the at least one attribute and the spatio-temporal attributes; and
notifying an operator of the one or more events.

16. The method of claim 1, wherein the plurality of images are at least a portion of a video.

17. The method of claim 1, wherein the plurality of images comprise a visible light image, an infrared image, an ultraviolet image, a thermal image, a night vision image, or any combination thereof.

18. The method of claim 1, wherein the plurality of images comprise images from two or more different videos.

19. The method of claim 1, wherein the one or more elements comprise a person, a group of people, a vehicle, equipment or a component thereof, or any combination thereof.

20. The method of claim 1, wherein the at least one sensor comprises an identification scanner, a barrier sensor, an equipment sensor, and any combination thereof.
